(19) United States
(12) Patent Application Publication
(10) Pub. No.: US 2018/0016839 A1
(43) Pub. Date: Jan. 18, 2018

(54) OUTDOOR WIND-BLOCKING ASSEMBLY

(71) Applicant: Seong deok JEONG, Gangwon-do (KR)

(72) Inventor: Seong deok JEONG, Gangwon-do (KR)

(21) Appl. No.: 15/492,379

(22) Filed: Apr. 20, 2017

(30) Foreign Application Priority Data
Jul. 14, 2016 (KR) 20-2016-0004051

(51) Int. Cl. E06B 5/10; E06B 9/08

(52) U.S. Cl. CPC E06B 5/10; E06B 9/08

(57) ABSTRACT

There is provided an outdoor wind-blocking assembly having a flexible wind-blocking sheet, the assembly including: supporting means configured to vertically support the flexible wind-blocking sheet; fixing means configured to fix the supporting means to a ground; and wind-blocking means having the flexible wind-blocking sheet and configured to allow the flexible wind-blocking sheet to be in extended or retracted states.

### CROSS-REFERENCE TO RELATED APPLICATION

This application claims the benefit of Korean utility model application No. 20-2016-0004051 filed on Jul. 14, 2016, the entire content of which is incorporated herein by reference for all purposes as if fully set forth herein.

### BACKGROUND

### Field of the Present Disclosure

The present disclosure relates to an outdoor wind-blocking assembly, and, more particularly, to an outdoor wind-blocking assembly to allow a fire on an outdoor burner to be protected from a wind.

### Discussion of Related Art

As known, portable gas stoves are used in outdoor rather than indoors. Thus, a windscreen is essential for protecting the firepower of the gas stove from natural winds to minimize heat loss and to smooth food cooking. The windshield used to protect the firepower of the gas stove from the wind blowing from the surroundings when the food is cooked by the gas stove in the outdoors has been manufactured or marketed in various forms.

Among the above windshields, a foldable type windshield has a low purchase price and is structurally simple. Such a windshield is configured to surround the outer periphery of the gas stove. The windshield is configured to be installed on the floor where the gas stove is placed and to surround a part of the cooking vessel.

Such a windshield has a high height and a long length in order to widen the blocking range. This causes a problem in that it is bulky and inconvenient to carry. In addition, when the windshield is installed upright on the floor, the windshield may collapse due to the strong wind.

A prior art document is as follows: Korean utility model registration No. 20-0399921

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter.

The present disclosure is to provide an outdoor wind-blocking assembly to allow a fire on an outdoor burner to be protected from a wind. The present disclosure is to provide an outdoor wind-blocking assembly where a flexible wind-blocking sheet may be wound or unwound around a shaft, thereby to allow the outdoor wind-blocking assembly to have a reduced volume and easy potable ability.

In one aspect of the present disclosure, there is provided an outdoor wind-blocking assembly having a flexible wind-blocking sheet, the assembly including: supporting means configured to vertically support the flexible wind-blocking sheet; fixing means configured to fix the supporting means to a ground; and wind-blocking means having the flexible wind-blocking sheet and configured to allow the flexible wind-blocking sheet to be in extended or retracted states.

In one embodiment, the supporting means may include first and second rigid vertical plates connected to each other via a vertical hinge shaft so as to fold toward each other, and wherein the supporting means includes first and second vertical support shafts coupled to hingeless ends of the first and second rigid vertical plates respectively.

In one embodiment, the wind-blocking means may include: a rotation shaft rotatably received in each of the first and second vertical support shafts; the flexible wind-blocking sheet wound around the rotation shaft; and an elastic member accommodated in the rotation shaft, wherein the elastic member is fixed to each of the first and second vertical support shafts, and to the rotation shaft, wherein the elastic member is configured such that: when the flexible wind-blocking sheet is unwound around the rotation shaft via an eternal force together with a rotation of the rotation shaft in a first direction to reach the extended state of the sheet, the elastic member is compressed to have an elastic recovery force, and when the eternal force is removed, the elastic recovery force of the elastic member allows the flexible wind-blocking sheet to be wound around the rotation shaft together with a rotation of the rotation shaft in a second direction opposite the first direction to reach the retracted state thereof.

In one embodiment, each of the first and second vertical support shafts may have a top end having a protrusion extending upwards therefrom, and a bottom end having a groove defined therein.

In one embodiment, the fixing means may have a head, and a protrusion extending upwards from the head to be inserted into the groove defined in each of the first and second vertical support shafts, and a sharpened rod extending downwards from the head to be inserted into a ground.

In one embodiment, the protrusion of the fixing means may be fitted into the groove defined in the bottom end of each of the first and second vertical support shafts.

In one embodiment, a supporting wire may be connected to each of the first and second vertical support shafts at a top end thereof.

In one embodiment, the other end of the flexible wind-blocking sheet may be fixed to a third vertical support shaft.

In one embodiment, further wind-blocking means may be received in the third vertical support shaft.

In one embodiment, a further rotation shaft, a further elastic member and a further elastic member may be accommodated in the third vertical support shaft, and the other end of the flexible wind-blocking sheet facing away one end thereof coupled to each of the first and second vertical support shafts may be coupled to the further elastic member.

In one embodiment, multiple outdoor wind-blocking assemblies may be arranged and neighboring third vertical support shafts may be coupled to each other via rubber rings.

In accordance with the present outdoor wind-blocking assembly, the supporting means may be configured such that rigid vertical plates may be coupled to each other via a hinge, and, thus, an angle between the rigid vertical plates may be adjusted by a desired degree. This may allow the user to stand the rigid vertical plates vertically on the ground.

In accordance with the present outdoor wind-blocking assembly, the wind-blocking sheet may be retracted into or extended from each of the first and second vertical support shafts of the supporting means. When the wind-blocking sheet may be retracted in each of the first and second vertical support shafts of the supporting means, carrying and storing the outdoor wind-blocking assembly may be easy. Further, when using the outdoor wind-blocking assembly, the wind-blocking sheet may be extended from each of the first and second vertical support shafts of the supporting means by a desired length.

Moreover, in accordance with the present outdoor wind-blocking assembly, each of the first and second vertical support shafts has the groove at the bottom end thereof and the protrusion at a top end thereof. Thus, multiple supporting means may be arranged vertically to form a desired height of the stack of the wind-blocking assemblies.

### BRIEF DESCRIPTION OF THE DRAWINGS

The accompanying drawings, which are incorporated in and form a part of this specification and in which like numerals depict like elements, illustrate embodiments of the present disclosure and, together with the description, serve to explain the principles of the disclosure.

FIG. 1 shows a perspective view of an outdoor wind-blocking assembly in accordance with one embodiment of the present disclosure.

FIG. 2 shows a top view of an outdoor wind-blocking assembly in accordance with one embodiment of the present disclosure in an extended state.

FIG. 3 shows a top view of an outdoor wind-blocking assembly in accordance with one embodiment of the present disclosure in a retracted state.

FIG. 4 shows a cross-sectional view of a supporting shaft of an outdoor wind-blocking assembly in accordance with one embodiment of the present disclosure.

FIG. 5 shows a perspective view of an outdoor wind-blocking assembly in accordance with another embodiment of the present disclosure.

FIG. 6 shows a top view of an outdoor wind-blocking assembly in accordance with another embodiment of the present disclosure in an extended state.

For simplicity and clarity of illustration, elements in the figures are not necessarily drawn to scale. The same reference numbers in different figures denote the same or similar elements, and as such perform similar functionality. Also, descriptions and details of well-known steps and elements are omitted for simplicity of the description. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

### DETAILED DESCRIPTIONS

Examples of various embodiments are illustrated and described further below. It will be understood that the description herein is not intended to limit the claims to the specific embodiments described. On the contrary, it is intended to cover alternatives, modifications, and equivalents as may be included within the spirit and scope of the present disclosure as defined by the appended claims.

It will be understood that, although the terms “first”, “second”, “third”, and so on may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

It will be understood that when an element or layer is referred to as being “connected to”, or “coupled to” another element or layer, it can be directly on, connected to, or coupled to the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present.

Spatially relative terms, such as “beneath,” “below,” “lower,” “under,” “above,” “upper,” and the like, may be used herein for ease of explanation to describe one element or feature's relationship to another element s or feature s as illustrated in the figures. It will be understood that the spatially relative terms are intended to encompass different orientations of the assembly in use or in operation, in addition to the orientation depicted in the figures. For example, if the assembly in the figures is turned over, elements described as “below” or “beneath” or “under” other elements or features would then be oriented “above” the other elements or features. Thus, the example terms “below” and “under” can encompass both an orientation of above and below. The assembly may be otherwise oriented for example, rotated 90 degrees or at other orientations, and the spatially relative descriptors used herein should be interpreted accordingly.

The terminology used herein is for the purpose of describing particular embodiments only and is not intended to be limiting of the present disclosure. As used herein, the singular forms “a” and “an” are intended to include the plural forms as well, unless the context clearly indicates otherwise. It will be further understood that the terms “comprises”, “comprising”, “includes”, and “including” when used in this specification, specify the presence of the stated features, integers, operations, elements, and/or components, but do not preclude the presence or addition of one or more other features, integers, operations, elements, components, and/or portions thereof. As used herein, the term “and/or” includes any and all combinations of one or more of the associated listed items. Expression such as “at least one of” when preceding a list of elements may modify the entire list of elements and may not modify the individual elements of the list.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In the following description, numerous specific details are set forth in order to provide a thorough understanding of the present disclosure. The present disclosure may be practiced without some or all of these specific details. In other instances, well-known process structures and/or processes have not been described in detail in order not to unnecessarily obscure the present disclosure.

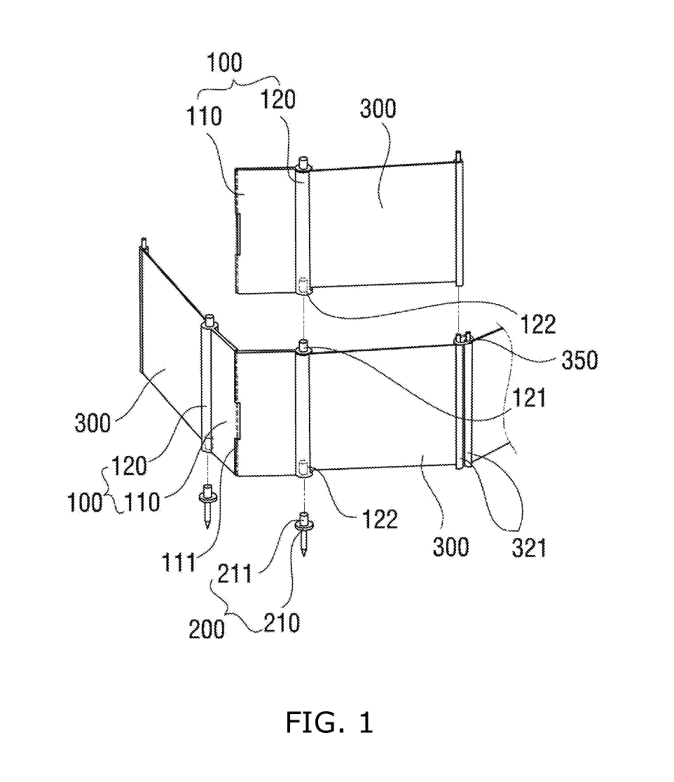

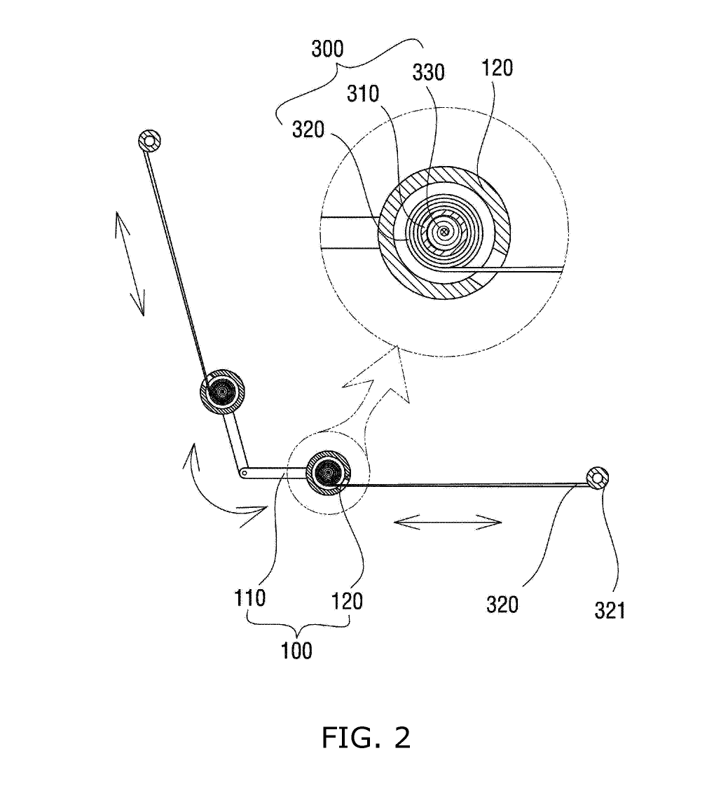

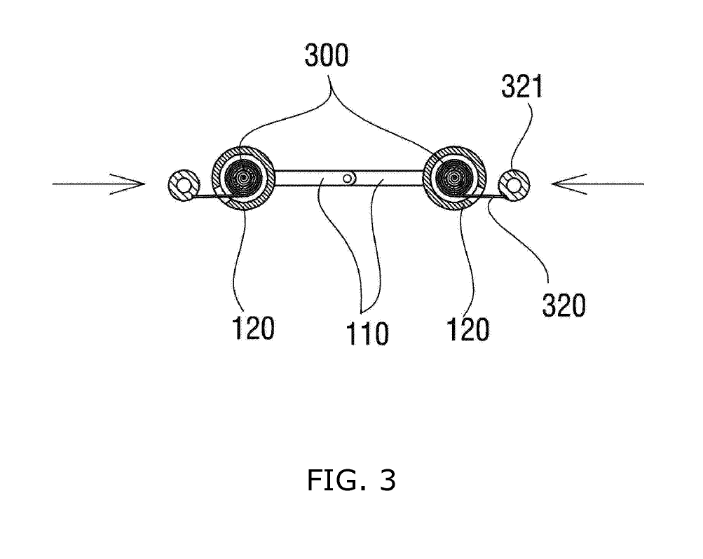

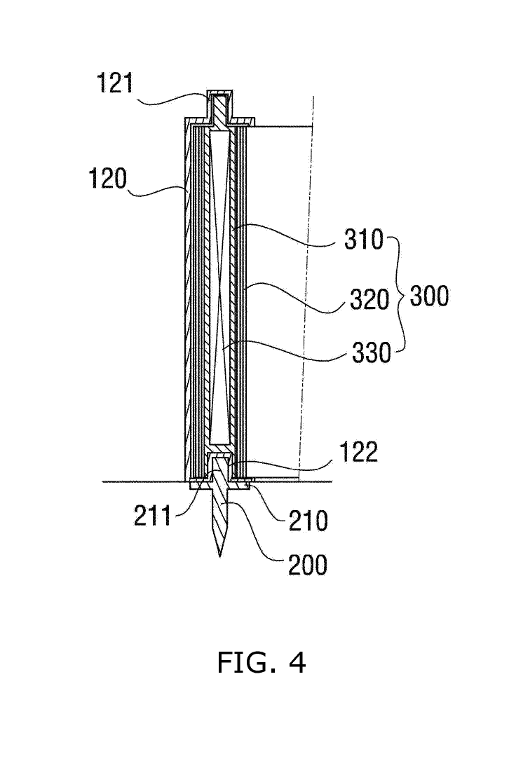

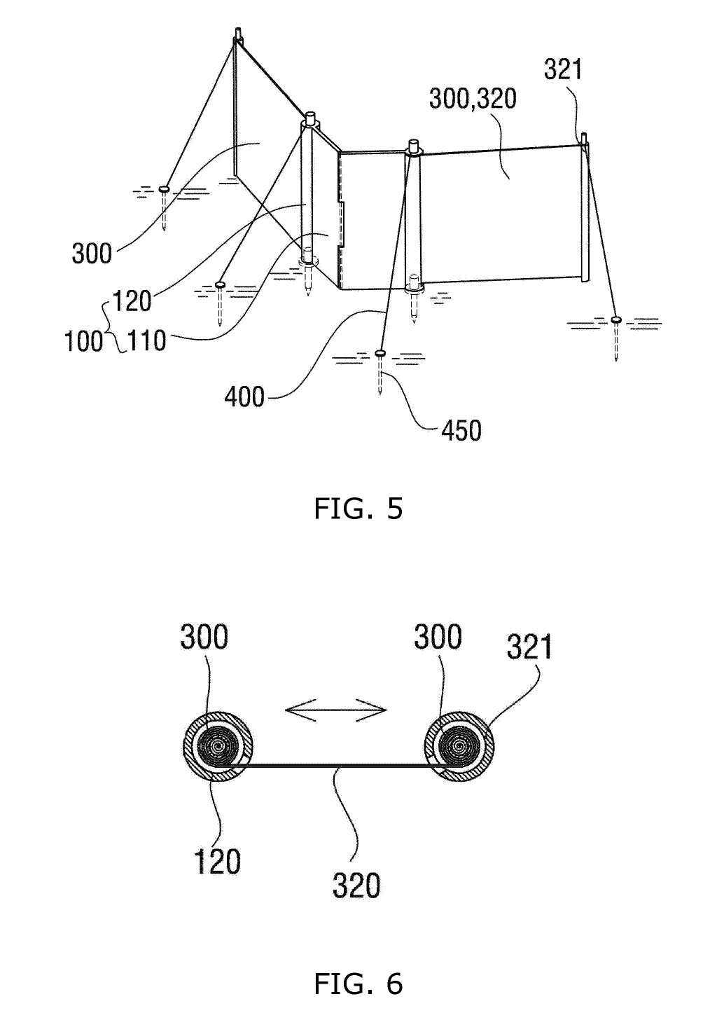

FIG. 1 shows a perspective view of an outdoor wind-blocking assembly in accordance with one embodiment of the present disclosure. FIG. 2 shows a top view of an outdoor wind-blocking assembly in accordance with one embodiment of the present disclosure in an extended state. FIG. 3 shows a top view of an outdoor wind-blocking assembly in accordance with one embodiment of the present disclosure in a retraced state. FIG. 4 shows a cross-sectional view of a supporting shaft of an outdoor wind-blocking assembly in accordance with one embodiment of the present disclosure. FIG. 5 shows a perspective view of an outdoor wind-blocking assembly in accordance with another embodiment of the present disclosure. FIG. 6 shows a top view of an outdoor wind-blocking assembly in accordance with another embodiment of the present disclosure in an extended state.

As shown in FIG. 1 to FIG. 5, the outdoor wind-blocking assembly in accordance with one embodiment of the present disclosure may include supporting means 100, fixing means 200, and wind-blocking means 300.

The supporting means 100 may include at least two rigid vertical plates 110 which are connected to each other via a hinge to be foldable.

In one embodiment, the supporting means 100 may have first and second rigid vertical plates 110 which are connected to each other via a vertical hinge shaft 111 so as to fold toward each other. The supporting means 100 may have first and second vertical support shafts 120 coupled to hingeless ends of the first and second rigid vertical plates 110 respectively.

Each of the first and second vertical support shafts 120 may receive the wind-blocking means 300 therein, as will be described later.

Each of the first and second vertical support shafts 120 may have a top end having a protrusion 121 extending upwards therefrom, and a bottom end having a groove 122 defined therein.

The protrusion 121 and the groove 122 may be used to stack multiple supporting means 100, that is, to vertically arrange multiple first or second vertical support shafts 120. The protrusion 121 of the first lower vertical support shaft 120 of lower supporting means 100 may be engaged into the groove 122 of the first upper vertical support shaft 120 of upper supporting means 100.

In this case, the groove 122 may be used to receive the fixing means 200 such as an anchor.

The position of the groove and protrusion may not be limited thereto. In one embodiment, each of the first and second vertical support shafts 120 may have a bottom end having a protrusion 121 extending downwards therefrom, and a top end having a groove 122 defined therein.

The fixing means 200 may have a head 210, and a protrusion 211 extending upwards from the head 210 to be inserted into the groove 122 defined in each of the first and second vertical support shafts 120, and a sharpened rod extending downwards from the head 210 to be inserted into a ground.

The protrusion 211 of the fixing means 200 may be fitted into the groove 122 defined in the bottom end of each of the first and second vertical support shaft 120s. In this way, the supporting means 100 may stand vertically.

As shown in FIG. 5, in order to prevent the supporting means 100 from collapsing, a supporting wire 400 may be connected to each of the first and second vertical support shafts 120 at a top end thereof. In this connection, the supporting wire 400 has one end fixed to each of the first and second vertical support shafts 120 at the top end and the other end fixed to the ground via a further anchor 450 which fixes the supporting wire 400 to the ground.

The supporting wire 400 may be wound within each of the first and second vertical support shafts 120 in the same manner as in the wind-blocking means 300 as will be described later.

The wind-blocking means 300 may be received in each of the first and second vertical support shafts 120 in a retracted state thereof, for example, for carrying the present outdoor wind blocking assembly. In an expanded state for activation of the wind block, a flexible wind-blocking sheet 320 of the wind-blocking means 300 may be stretched out by a certain force. Upon removal of the force, the flexible wind-blocking sheet 320 may be retracted into each of the first and second vertical support shafts 120 via a recovery force of the elastic member. This extending and retracting may be carried out in a rolling and unrolling manner. To this end, as shown in FIG. 4, the wind-blocking means 300 may include a rotation shaft 310, a flexible wind-blocking sheet 320 and an elastic member 330.

The rotation shaft 310 may be cylindrical and elongate. The rotation shaft 310 may be rotatably received in each of the first and second vertical support shafts 120.

The flexible wind-blocking sheet 320 may be made of heat-resistance material and may be thin. The flexible wind-blocking sheet 320 may be wound around the rotation shaft 310.

One end of the flexible wind-blocking sheet 320 may be fixed to the rotation shaft 310. Thus, upon the rotation of the rotation shaft 310, the flexible wind-blocking sheet 320 may be wound or unwound around the rotation shaft 310 depending on the rotation direction of the rotation shaft 310.

The other end of the flexible wind-blocking sheet 320 may be fixed to a third vertical support shaft 321.

The elastic member 330 may be received in the rotation shaft 310. The elastic member 330 may be embodied as a spiral spring.

The elastic member 330 may have a middle end fixed to each of the first and second vertical support shafts 120, and a distal end coupled to the rotation shaft 310.

The flexible wind-blocking sheet 320 may be unwound around the rotation shaft 310 by pulling the flexible wind-blocking sheet 320 horizontally and away from the first vertical support shaft 220, while the rotation shaft 310 rotate in a first direction. In this way, the flexible wind-blocking sheet 320 may be extended.

This extended state may allow the elastic member 330 to be compressed. In this state, the flexible wind-blocking sheet 320 may be fixed via the third vertical support shaft 321 fixed to the ground. Due to the elastic recovery force of the elastic member 330, the flexible wind-blocking sheet 320 may be kept flat and tense.

When the fixing of the flexible wind-blocking sheet 320 to the ground is released or the force to stretch the flexible wind-blocking sheet 320 is removed, due to the elastic recovery force of the elastic member 330, the rotation shaft 310 may rotate in a second direction opposite to the first direction. In this way, the flexible wind-blocking sheet 320 may be wound around the rotation shaft 310 and may be retracted into each of the first and second vertical support shafts 120.

The wind-blocking means 300 may be received not only in each of the first and second vertical support shafts 120 but also in the third vertical support shaft 321.

More specifically, as shown in FIG. 6, the rotation shaft 310 and the elastic member 330 may be accommodated in the third vertical support shaft 321 in a manner as described above. The other end of the flexible wind-blocking sheet 320 facing away one end thereof coupled to each of the first and second vertical support shafts 120 may be coupled to the elastic member 330 accommodated in the third vertical support shaft 321.

When necessary, each of the first and second vertical support shafts 120 may be employed without the rigid plates 110.

In this embodiment as shown in FIG. 6, where the rotation shaft 310 and the elastic member 330 and the elastic member 330 are accommodated in the third vertical support shaft 321, and the other end of the flexible wind-blocking sheet 320 facing away one end thereof coupled to each of the first and second vertical support shafts 120 is coupled to the elastic member 330, in other words, where the wind-blocking means 300 is accommodated in the third vertical support shaft 321, a length of the flexible wind-blocking sheet 320 may be further enlarged.

In one embodiment, multiple outdoor wind-blocking assemblies may be arranged in a desired form. In this connection, as shown in FIG. 1, neighboring third vertical support shafts 321 may be coupled to each other via rubber rings 350.

As for the outdoor wind-blocking assembly in accordance with one embodiment of the present disclosure, the supporting means 100 may be configured such that rigid vertical plates 110 may be coupled to each other via a hinge, and, thus, an angle between the rigid vertical plates 110 may be adjusted by a desired degree. This may allow the user to stand the rigid vertical plates 110 vertically on the ground.

The wind-blocking sheet 320 may be retracted into or extended from each of the first and second vertical support shafts 120 of the supporting means 100. When the wind-blocking sheet 320 may be retracted in each of the first and second vertical support shafts 120 of the supporting means 100, carrying and storing the outdoor wind-blocking assembly may be easy. Further, when using the outdoor wind-blocking assembly, the wind-blocking sheet 320 may be extended from each of the first and second vertical support shafts 120 of the supporting means 100 by a desired length.

Moreover, each of the first and second vertical support shafts 120 has the groove 122 at the bottom end thereof and the protrusion 121 at a top end thereof. Thus, multiple supporting means 100 may be arranged vertically to form a desired height of the stack of the wind-blocking assemblies.

The above description is not to be taken in a limiting sense, but is made merely for the purpose of describing the general principles of exemplary embodiments, and many additional embodiments of this disclosure are possible. It is understood that no limitation of the scope of the disclosure is thereby intended. The scope of the disclosure should be determined with reference to the Claims. Reference throughout this specification to “one embodiment,” “an embodiment,” or similar language means that a particular feature, structure, or characteristic that is described in connection with the embodiment is included in at least one embodiment of the present disclosure. Thus, appearances of the phrases “in one embodiment,” “in an embodiment,” and similar language throughout this specification may, but do not necessarily, all refer to the same embodiment.

What is claimed is:

1. An outdoor wind-blocking assembly having a flexible wind-blocking sheet, the assembly including:
supporting means configured to vertically support the flexible wind-blocking sheet;
fixing means configured to fix the supporting means to a ground; and
wind-blocking means configured to allow the flexible wind-blocking sheet to be in extended or retracted states,
wherein the supporting means includes first and second rigid vertical plates connected to each other via a vertical hinge shaft so as to fold toward each other, and wherein the supporting means includes first and second vertical support shafts coupled to hingeless ends of the first and second rigid vertical plates respectively,
wherein the wind-blocking means includes:
a rotation shaft rotatably received in each of the first and second vertical support shafts;
the flexible wind-blocking sheet wound around the rotation shaft; and
an elastic member accommodated in the rotation shaft, wherein the elastic member is fixed to each of the first and second vertical support shafts, and to the rotation shaft,
wherein the elastic member is configured such that:
when the flexible wind-blocking sheet is unwound around the rotation shaft via an eternal force together with a rotation of the rotation shaft in a first direction to reach the extended state of the sheet, the elastic member is compressed to have an elastic recovery force, and
when the eternal force is removed, the elastic recovery force of the elastic member allows the flexible wind-blocking sheet to be wound around the rotation shaft together with a rotation of the rotation shaft in a second direction opposite the first direction to reach the retracted state thereof.

2. The assembly of claim 1, wherein each of the first and second vertical support shafts has a top end having a protrusion extending upwards therefrom, and a bottom end having a groove defined therein.
